(19) United States
(12) Patent Application Publication
(10) Pub. No.: US 2026/0107265 A1
(43) Pub. Date: Apr. 16, 2026

(54) MANAGING UPLINK TRANSMISSION CHAIN SWITCHING

(71) Applicant: GOOGLE LLC, Mountain View, CA (US)

(72) Inventors: Kao-Peng Chou, Taoyuan City (TW); Chih-Hsiang Wu, Taoyuan City (TW)

(21) Appl. No.: 19/116,925

(22) PCT Filed: Sep. 29, 2023
(86) PCT No.: PCT/US2023/075655

§ 371 Date: Mar. 28, 2025

Related U.S. Application Data
(60) Provisional application No. 63/377,694, filed on Sep. 29, 2022.

(51) Int. Cl. H04W 72/0453; H04W 72/232

(52) U.S. Cl. CPC H04W 72/0453; H04W 72/232

(57) ABSTRACT

A method in a user equipment (UE) equipped with a first transmitter and a second transmitter, the method comprising: transmitting a first uplink transmission using the first transmitter switched to a first frequency band and using a second transmitter switched to a second frequency band; and receiving, from a radio access network (RAN), an uplink switching configuration for a second uplink transmission using the first transmitter, the uplink switching configuration including (i) a first parameter to indicate whether to switch the second transmitter away from the second frequency band, and (ii) a second parameter indicating to which frequency band the UE is to switch the second transmitter; transmitting the second uplink transmission in accordance with the uplink switching configuration.

### CROSS-REFERENCE TO RELATED APPLICATIONS

This application claims priority to and the benefit of the filing date of provisional U.S. Patent Application No. 63/377,694 entitled “MANAGING UPLINK TRANSMISSION CHAIN SWITCHING,” filed on Sep. 29, 2022. The entire contents of the provisional application are hereby expressly incorporated herein by reference.

### FIELD OF THE DISCLOSURE

This disclosure relates to wireless communications and, more particularly, to support uplink (UL) transmitter switching between multiple carrier frequencies or frequency bands.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

For some user equipment (UEs), if a UE has two transmitters and is configured with physical uplink (UL) shared channels (PUSCH) in component carriers in 2 bands, the UE configures one transmitter (also referred to as a Tx or antenna) for component carrier(s) in one band and configures another transmitter for component carrier(s) in another band. However, in some scenarios, the base station only schedules transmissions in one band. As such, one transmitter remains in an idle state. To better utilize the idle transmitter, UL switching technology supports scenarios such as inter-band evolved universal terrestrial radio access network (E-UTRAN) new radio (NR) dual connectivity (DC) (EN-DC) without simultaneous uplink (SUL), inter-band UL carrier aggregation (CA), and standalone SUL. Regarding the Tx states, two cases, Case 1 and Case 2, are supported in some UL switching. Case 1 depicts a Tx state where the UE respectively configures 2 transmitters for 2 component carriers (1T-1T). In Case 2, the UE configures 2 transmitters for the second carrier (0T-2T).

In some scenarios, each Tx state supports transmissions with different antenna port assignments without antenna switching. In some such examples, the Case 1 (1T-1T) Tx state supports 2 concurrent single port transmissions in 2 component carriers (1P-1P), single port transmission in component carrier 1 (1P-0P), and single port transmission in component carrier 2 (0P-1P). On the other hand, Case 2 (0T-2T) Tx state supports single port transmission in component carrier 2 (0P-1P), and 2-port transmission (UL-MIMO) in component carrier 2 (0P-2P). In some scenarios, the base station triggers the UE to switch Tx states by dynamic scheduling (i.e., using downlink control information (DCI)) and semi-static UL scheduling (i.e., by radio resource control (RRC) configured grant). If a UE has a Tx state in Case 2 and is scheduled with a single port transmission in component carrier 1 (1P-0P), because the UE currently has no Tx configured to component carrier 1, the UE switches one Tx to component carrier 1 to perform such a transmission.

In further scenarios, UL switching was enhanced to support 2-port transmission in the component carrier 1 (Case 3). The newly added Case 3 leads to an ambiguous issue when a UE performs UL switching. In a scenario, the last transmission that the UE performed on carrier 2 is a 2-port transmission (i.e., 0P-2P in Case 2), and the UE receives, from a gNB, a DCI scheduling a 1-port transmission on carrier 1 (i.e., 1P-0P in Case 1 or Case 3). In such a scenario, the UE performs UL switching (e.g., antenna port switching, UL transmission chain switching, or UL transmit (Tx) switching) to transmit the 1-port transmission. During the UL switching, the UE switches one of the two antenna ports from carrier 2 to carrier 1 and transmits the 1-port transmission using the switched antenna port. However, the UE has to determine whether to change the Tx state (i.e., whether to switch the other antenna port from carrier 2 to carrier 1 (e.g., Case 3 or Case 1)). The gNB also must know the Tx state of the UE to schedule the next uplink transmission. A new radio resource control (RRC) parameter was introduced to resolve the ambiguity (e.g., uplinkTxSwitching-DualUL-TxState-r17), which is able to be set with a value oneT or twoT. In some such scenarios, the gNB sends, to the UE, the uplinkTxSwitching-DualUL-TxState-r17 set to oneT to configure the UE not to switch the other antenna port in the above scenario. Thus, the UE does not switch the other antenna port after transmitting the 1-port transmission in accordance with the oneT value. Alternatively, the gNB sends, to the UE, the uplinkTxSwitching-DualUL-TxState-r17 set to twoT to configure the UE to switch the other antenna port from carrier 2 to carrier 1 in the above scenario. Thus, the UE switches the other antenna port from carrier 2 to carrier 1 after transmitting the 1-port transmission in accordance with the twoT value.

### SUMMARY

An example embodiment of the techniques of this disclosure is a method in a user equipment (UE) equipped with a first transmitter and a second transmitter, the method comprising: transmitting a first uplink transmission using the first transmitter switched to a first frequency band and using a second transmitter switched to a second frequency band; and receiving, from a radio access network (RAN), an uplink switching configuration for a second uplink transmission using the first transmitter, the uplink switching configuration including (i) a first parameter to indicate whether to switch the second transmitter away from the second frequency band, and (ii) a second parameter indicating to which frequency band the UE is to switch the second transmitter; transmitting the second uplink transmission in accordance with the uplink switching configuration.

Another example embodiment of the techniques is a method in a radio access network (RAN) node, the method comprising: receiving, from a user equipment (UE) equipped with a first transmitter and a second transmitter, a first uplink transmission over a first frequency band and a second frequency band; and transmitting, to the UE, an uplink switching configuration for a second uplink transmission over a third frequency band, the uplink switching configuration including (i) a first parameter to indicate whether to switch the second transmitter away from the second frequency band, and (ii) a second parameter indicating to which frequency band the UE is to switch the second transmitter.

### BRIEF DESCRIPTION OF THE DRAWINGS

FIG. 1A is a block diagram of an example wireless communication system in which a RAN and/or a UE implement the techniques of this disclosure for managing Tx state for UL switching;

FIG. 1B is a block diagram of an example base station including a central unit (CU) and a distributed unit (DU) that can operate in the system of FIG. 1A;

FIG. 2 is a block diagram of an example protocol stack according to which the UE of FIG. 1A communicates with base stations;

FIG. 3 is a messaging diagram of an example of UL switching;

FIG. 4A is a messaging diagram for delivering a UL switching configuration under DC with a particular cell group configuration path;

FIG. 4B is a messaging diagram similar to that of FIG. 4A, in which the scenario is performed using a different cell group configuration path;

FIG. 5 is a flow diagram of an example method 500 describes a general UE procedures in UL switching;

FIG. 6 is a flow diagram of an example method 600, where a UE determines the Tx state when non-unique UL switching case occurs according to a cell index configured by the base station;

FIG. 7A is a flow diagram of an example method 700A, where a UE determines the Tx state when non-unique UL switching case occurs according to cell/band priority configured by the base station;

FIG. 7B is a flow diagram of an example method 700B, where a UE determines the Tx state when non-unique UL switching case occurs according to cell indexes configured by the base station;

FIG. 8 is a flow diagram of an example method 800, where a UE determines the Tx state when non-unique UL switching case occurs according to the Tx station indication of each non-unique UL switching cases configured by the base station;

FIG. 9A is a flow diagram of an example method 900A, where a UE determines the Tx states according to the cell/band indicator carried by a scheduling DCI format;

FIG. 9B is a flow diagram of an example method 900B, similar to that of method 900A, but in which the UE determines whether to update a Tx state based on a last scheduling DCI according to whether a transmission is scheduled by a DCI;

FIG. 10A is a flow diagrams of an example method 1000A, where a UE determines the Tx state in accordance with a single UL switching Tx state configuration;

FIG. 10B is a flow diagram of an example method 1000B, similar to that of method 1000B, but in which the UE determines a Tx state in accordance with multiple UL switching Tx state configurations;

FIG. 10C is a flow diagram of an example method 1000C, which determines whether to update a current transmission configuration based on whether a determined Tx state is the same as a current Tx state;

FIG. 11A is a flow diagram of an example method 1100A, in which a base station transmits an indication for UL switching TX state for a non-scheduled Tx;

FIG. 11B is a flow diagram of an example method 1100B, similar to that of method 1100A, but in which the base station transmits UL Tx switching priorities for the cells;

FIG. 11C is a flow diagram of an example method 1100C, similar to that of method 1100A, but in which the base station transmits serving cell indexes to the UE;

FIG. 11D is a flow diagram of an example method 11001D, similar to that of method 1100A, but in which the base station transmits UL switching Tx state configurations for each non-unique UL switching case;

FIG. 11E is a flow diagram of an example method 1100E, similar to that of method 1100A, but in which the base station transmits a UL switching configuration enabling a field in a DCI format;

FIG. 11F is a flow diagram of an example method 1100F, similar to that of method 1100A, but in which the base station transmits a single UL switching Tx states configuration to the UE; and

FIG. 11G is a flow diagram of an example method 1100G, similar to that of method 1100A, but in which the base station transmits a first UL switching Tx state configuration and a second UL switching Tx state configuration to the UE.

### DETAILED DESCRIPTION OF THE DRAWINGS

Generally speaking, the techniques of the disclosure introduce a UL switching configuration with Tx selection indication for UE to configure Tx states across cells in at least 3 frequency bands. UE triggers UL switching based on base station scheduled (by DCI or RRC) UL transmissions. In some scenarios, a scheduled UL transmission may associate with multiple Tx states, which introduces ambiguity between base station and UE. With the antenna selection indication in the UL switching configuration, UE follows the UL switching rules to update the Tx state, and thereby resolves the non-unique Tx state issue.

Increasing the number of supported bands further, to 3 and 4, also increases the number of cases to 6 and 10, respectively, as shown in Table 2 and Table 3.

In some scenarios, the last transmission that the UE performed on carrier 2 is a 2-port transmission (i.e., 0P-2P-0P in Case 5) and the UE receives from a gNB a DCI scheduling a 1-port transmission on carrier 1 (e.g., 1P-0P-0P in Case 1, Case 3 or Case 4). In such a scenario, the UE performs UL switching (e.g., antenna port switching, UL transmission chain switching, or UL Tx switching) to transmit the 1-port transmission. In the UL switching, the UE switches one of the two antenna ports from carrier 2 to carrier 1 and transmits the 1-port transmission on carrier 1 using the switched antenna port. However, the UE further determines whether to switch the other antenna port from carrier 2 to carrier 1 (i.e., Case 4) or carrier 3 (e.g., Case 3) or remain the other antenna port for carrier 2 (i.e., Case 1). That is, the UE determines to configure the Tx state as Case 1, Case 3 or Case 4 upon receiving the DCI. The gNB also determines whether the UE applies the Tx state as Case 1, Case 3 or Case 4 in order to schedule the next uplink transmission. However, there is no means in current techniques for the UE and gNB to determine which Tx state is applied in such a scenario. A similar problem also occur in a scenario based 4 bands. Thus, the instant techniques illustrate how to determine a specific Tx state for the UE in the cases of UL switching between 3 and 4 bands. Further, a UE may not support all the UL Tx states due to implementation complexity, and thus the instant techniques further illustrate how to indicate supported UL Tx states.

Table 1, detailed below, indicates UL switching cases and antenna ports assignments for two carriers.

| | | “x” and “y” in xP-yP |
|---|---|---|
| | | represents the number of |
| | | antenna ports of carrier 1 |
| | Tx states on carrier 1 and | and carrier 2 assigned for uplink |
| | carrier 2, respectively | transmission(s), respectively |
| Case 1 | 1 Tx on carrier 1 and 1 Tx on | 1P-1P, 1P-0P, 0P-1P |
| | carrier 2 | |
| Case 2 | 0 Tx on carrier 1 and 2 Tx on | 0P-2P, 0P-1P |
| | carrier 2 | |
| Case 3 | 2 Tx on carrier 1 and 0 Tx on | 2P-0P, 1P-0P |
| | carrier 2 | |

Similarly, Table 2, detailed below, depicts UL switching cases and antenna port assignments for 3 carriers.

| | | “x”, “y” and “z” |
|---|---|---|
| | | in xP-yP-zP represents the |
| | Tx states | number of antenna ports of |
| | on carrier | carrier 1, 2, and 3 assigned |
| | 1, 2 and 3, | for uplink transmission(s), |
| | respectively | respectively |
| Case 1 | 1T-1T-0T | 1P-1P-0P, 1P-0P-0P, 0P-1P-0P |
| Case 2 | 0T-1T-1T | 0P-1P-1P, 0P-1P-0P, 0P-0P-1P |
| Case 3 | 1T-0T-1T | 1P-0P-1P, 1P-0P-0P, 0P-0P-1P |
| Case 4 | 2T-0T-0T | 2P-0P-0P, 1P-0P-0P |
| Case 5 | 0T-2T-0T | 0P-2P-0P, 0P-1P-0P |
| Case 6 | 0T-0T-2T | 0P-0P-2P, 0P-0P-1P |

Table 3, detailed below, depicts UL switching cases and antenna port assignments for 4 carriers.

| | | “a”, “b”, “c”, “d” |
|---|---|---|
| | Tx states on | in aP-bP-cP-dP represents the number of |
| | carrier | antenna ports of carrier 1, 2, 3, 4 |
| | 1, 2, 3, 4, | assigned for uplink transmission(s), |
| | respectively | respectively |
| Case 1 | 1T-1T-0T-0T | 1P-1P-0P-0P, 1P-0P-0P-0P, 0P-1P-0P-0P |
| Case 2 | 0T-1T-1T-0T | 0P-1P-1P-0P, 0P-1P-0P-0P, 0P-0P-1P-0P |
| Case 3 | 0T-0T-1T-1T | 0P-0P-1P-1P, 0P-0P-1P-0P, 0P-0P-0P-1P |
| Case 4 | 1T-0T-0T-1T | 1P-0P-0P-1P, 1P-0P-0P-0P, 0P-0P-0P-1P |
| Case 5 | 1T-0T-1T-0T | 1P-0P-1P-0P, 1P-0P-0P-0P, 0P-0P-1P-0P |
| Case 6 | 0T-1T-0T-1T | 0P-1P-0P-1P, 0P-1P-0P-0P, 0P-0P-0P-1P |
| Case 7 | 2T-0T-0T-0T | 2P-0P-0P-0P, 1P-0P-0P-0P |
| Case 8 | 0T-2T-0T-0T | 0P-2P-0P-0P, 0P-1P-0P-0P |
| Case 9 | 0T-0T-2T-0T | 0P-0P-2P-0P, 0P-0P-1P-0P |
| Case 10 | 0T-0T-0T-2T | 0P-0P-0P-2P, 0P-0P-0P-1P |

Table 4 depicts antenna port assignments of non-unique UL switching case and Tx states association regardless the current Tx state.

| | Antenna ports of carrier | Tx states for UL |
|---|---|---|
| Row index | 1, 2, and 3 | switching |
| 1 | 1P-0P-0P | Case 3 (1T-0T-1T) |
| 2 | 0P-1P-0P | Case 1 (1T-1T-0T) |
| 3 | 0P-0P-1P | Case 6 (0T-0T-2T) |

Similarly, Table 5 depicts antenna port assignments of non-unique UL switching case and Tx states association regarding the current Tx state.

| | | Antenna ports | |
|---|---|---|---|
| Row | | assignments of | New Tx states |
| index | c | carriers 1, 2, and 3 | for UL switching |
| 1 | Case 2 (0T-1T-1T) | 1P-0P-0P | Case 3 (1T-0T-1T) |
| 2 | Case 5 (0T-2T-0T) | | Case 1 (1T-1T-0T) |
| 3 | Case 6 (0T-0T-2T) | | Case 1 (1T-1T-0T) |
| 4 | Case 3 (1T-0T-1T) | 0P-1P-0P | Case 1 (1T-1T-0T) |
| 5 | Case 4 (2T-0T-0T) | | Case 2 (0T-1T-1T) |
| 6 | Case 6 (0T-0T-2T) | | Case 5 (0T-2T-0T) |
| 7 | Case 1 (1T-1T-0T) | 0P-0P-1P | Case 6 (0T-0T-2T) |
| 8 | Case 4 (2T-0T-0T) | | Case 6 (0T-0T-2T) |
| 9 | Case 5 (0T-2T-0T) | | Case 6 (0T-0T-2T) |

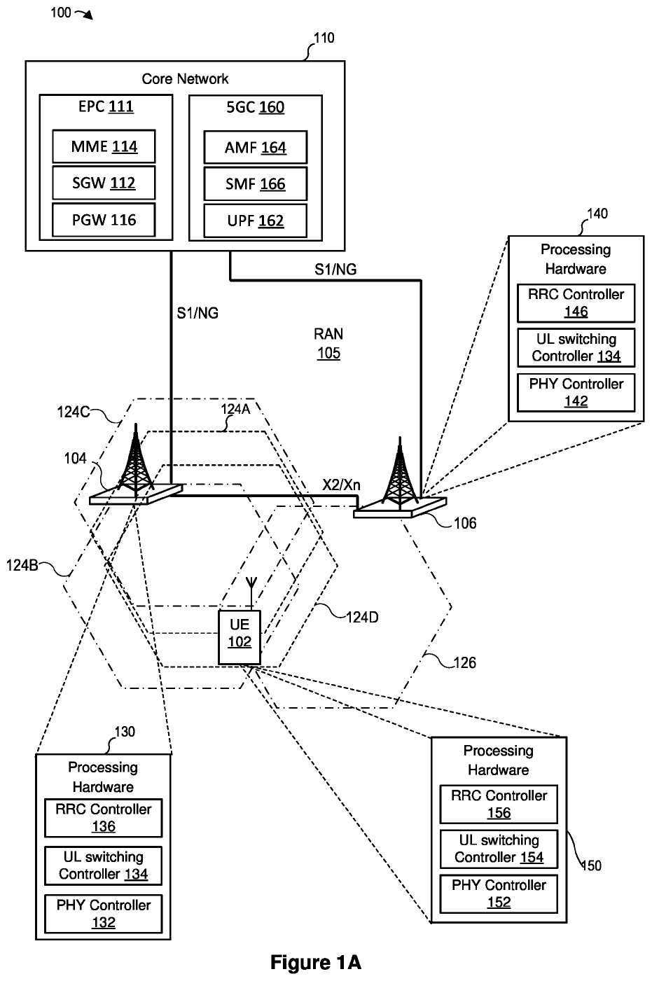

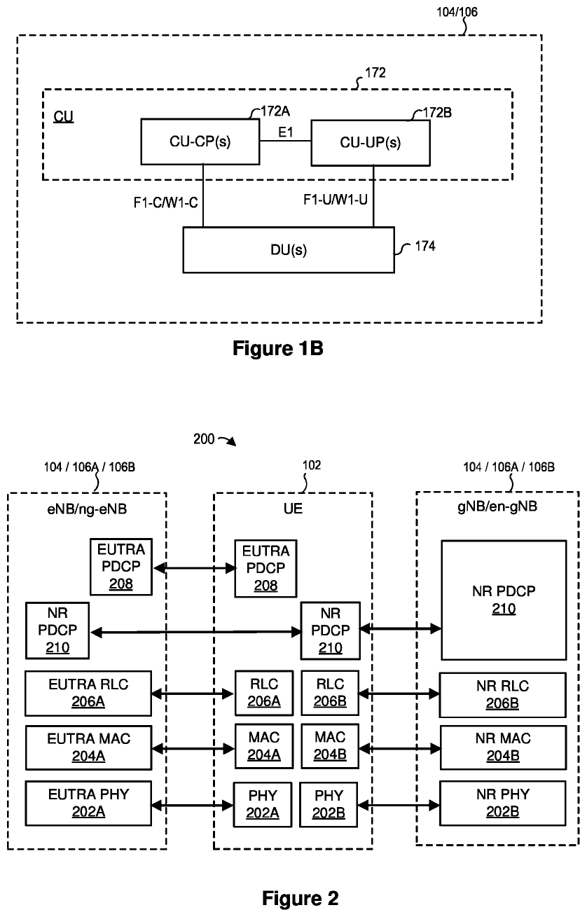

FIG. 1A depicts an example wireless communication system 100 that can implement UL switching techniques of this disclosure. The wireless communication system 100 includes UE 102A and UE 102B, as well as base stations 104, 106A, 106B of a radio access network (RAN) (e.g., RAN 105) that are connected to a core network (CN) 110. To ease readability, UE 102 is used herein to represent the UE 102A, the UE 102B, or both the UE 102A and UE 102B, unless otherwise specified. The base stations 104, 106A, 106B can be any suitable type, or types, of base stations, such as an evolved node B (eNB), a next-generation eNB (ng-eNB), or a 5G Node B (gNB), for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the UE 102 to operate in dual connectivity (DC) with the RAN 105. For example, the UE 102 can communicate in DC with the base station 104 (operating as a master node (MN)) and the base station 106A (operating as a secondary node (SN)) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE UL switching controller 152 that is configured to manage UE Tx state for UL transmission. For example, the UE UL switching controller 152 can be configured to support RRC configurations, procedures and messaging associated with UL switching procedures, and/or to support the necessary operations, as discussed below.

The CN 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is an Sng-eNB, the UE 102 can be in NR-EUTRA DC (NE-DC) with the MgNB 104 and the Sng-eNB 106A.

FIG. 1B depicts an example, distributed implementation of any one or more of the base stations 104, 106A, 106B. In this implementation, the base station 104, 106A, or 106B includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The processing hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the UL switching control information.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can application content for different services, e.g., IPv4/IPv6 multicast delivery, IPTV, software delivery over wireless, group communications, IoT applications, V2X applications, and/or emergency messages related to public safety.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as a MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2) or a DRB. The SN-terminated bearer can be an SRB or a DRB.

To simplify the following description, the UE 102 represents the UE 102A and the UE 102B, unless explicitly described.

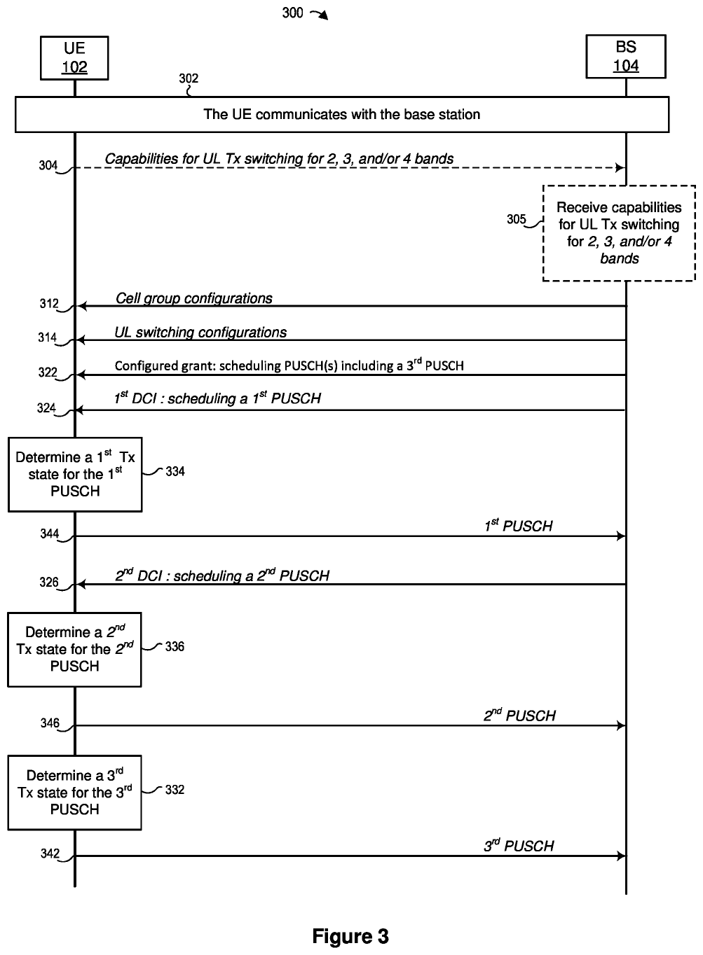

FIG. 3 shows an example scenario 300, which depicts message passing procedures for UL switching, where the UE 102 is equipped with a first and second Tx. The procedures begin with event 302, where the base station 104 communicates with the UE 102 to request UE capabilities regarding UL switching. In response to event 302, the UE 102 transmits 304, to the base station 104, capabilities for UL Tx switching for multiple (e.g., 2, 3, and/or 4) bands. In some implementations, the capabilities for UL Tx switching include UL switching related information such as band combinations, band pair list, MIMO capability per component carrier, supported UL switching options, switching period, and etc. At event 305, the base station 104 receives 304 capabilities for UL Tx switching for multiple (e.g., 2, 3, and/or 4) bands. Then the base station 104 transmits 312 a cell group configuration to the UE 102, wherein the cell group configuration includes SpCell configuration (e.g., SpCellConfig), SCell configuration (e.g., SCellConfig), and other parameters for UE 102 to transmit and/or receive signals from multiple cells. The base station 104 transmits 314 a UL switching configuration to the UE 102, including carrier indexes (e.g., uplinkTxSwitchingCarrier), UL switching options, ambiguous Tx states resolution indication (e.g., uplinkTxSwitching-DualUL-TxState), etc.

In further implementations, the base station 104 then transmits 322 a configured grant to the UE 102, scheduling one or more PUSCH transmissions, including scheduling 342 a third PUSCH transmission. The base station 104 transmits 324 a first DCI to the UE 102, where the first DCI schedules 344 a first PUSCH transmission. In response to receiving 324 the first DCI, the UE 102 determines 334 a first Tx state for the first and second Tx and transmits 344 the first PUSCH to the base station 104. Then, the base station 104 transmits 326 a second DCI to the UE 102, where the second DCI schedules 326 a second PUSCH transmission 346. In response to the second DCI 326, the UE 102 determines 336 a second Tx state for the first and second Tx and transmits 346 the second PUSCH to the base station 104. If the UE 102 determines 336 that the second Tx state is different from the first Tx state, the UE performs Tx switching. Then, according to the configured grant, the UE 102 determines 332 a third Tx state for the first and second Tx and transmits 342 the third PUSCH to the base station 104.

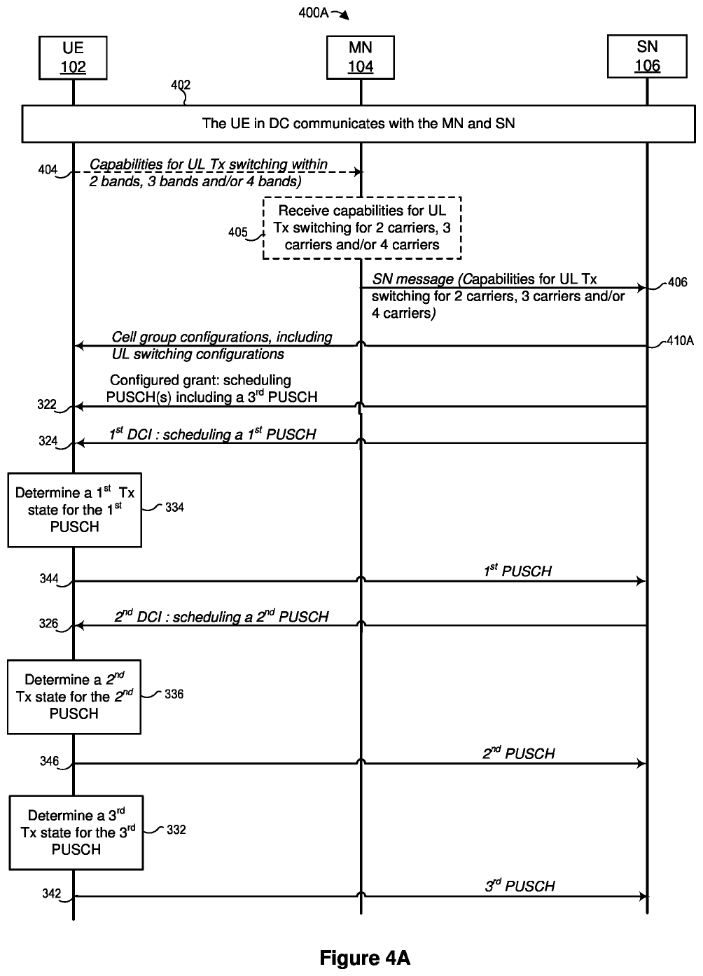

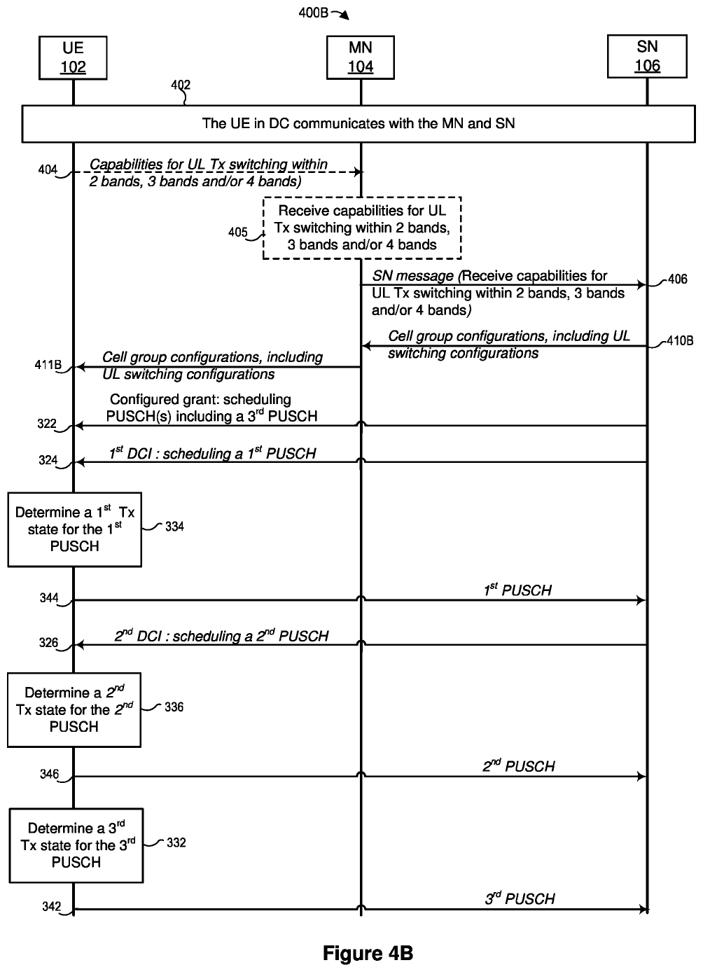

FIG. 4A shows an example scenario 400A, which is similar to the scenario 300. Differences between 400A and 300 are discussed below. At block 402, the UE 102 communicates with an MN 104 and SN 106 to request UE capabilities regarding UL switching. In response to event 402, the UE 102 transmits 404, to the MN 104, capabilities for UL Tx switching for multiple (e.g., 2, 3, and/or 4) bands. At event 405, the MN 104 receives 404 capabilities for UL Tx switching for multiple (e.g., 2, 3, and/or 4) bands. Then the MN 104 sends 406, to the SN 106, an SN message, including capabilities for UL Tx switching for multiple (e.g., 2, 3, and/or 4) bands. In accordance with the SN message, the SN 106 transmits 410A, to the UE 102, a cell group configuration including UL switching configurations.

FIG. 4B shows an example scenario 400A, which is similar to the scenarios 300 and 400A. Differences between scenario 400B and scenarios 300 or 400A are discussed below. In accordance with the SN message, the SN 106 sends 410B, to the MN 104, a cell group configuration including UL switching configurations. Then the MN 104 transmits 4111B, to the UE 102, a cell group configuration including UL switching configurations.

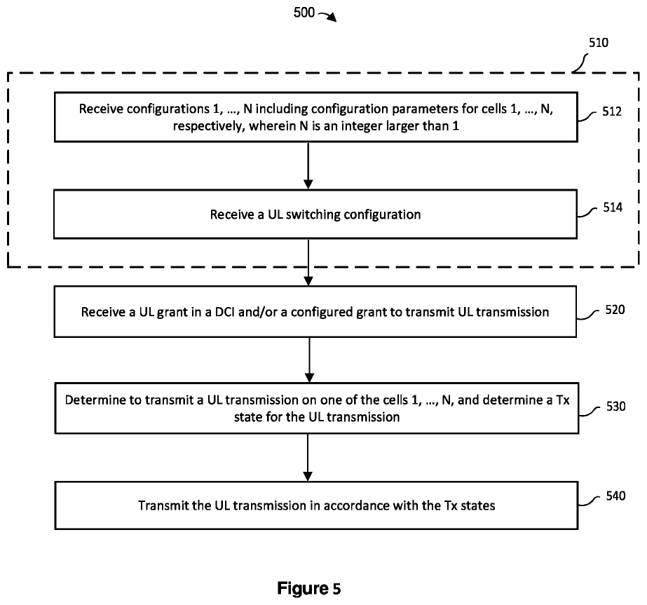

FIG. 5 illustrates a general method 500 of UE (such as UE 102) procedures in UL switching, which can be at least partially applied to the scenario 300 in FIG. 3, scenario 400A in FIG. 4A, and/or scenario 400B in FIG. 4B. At block 512, the UE 102 receives configurations 1, . . . , N including configuration parameters for cells 1, . . . , N, respectively, wherein N is an integer larger than 1 (e.g., cell group configurations, event 312). At block 514, the UE 102 receives (e.g., event 314) a UL switching configuration. At block 520, the UE 102 receives, from the base station (e.g., BS 104), a UL grant in a DCI and/or a configured grant (e.g., events 322, 324, and 326) to transmit PUSCH(s). At block 530, the UE 102 determines to transmit a UL transmission on one of the cells 1, . . . N, and determines Tx states for the UL transmission (e.g., events 332, 334, and 336). Finally, at block 550, the UE 102 transmits the UL transmission (e.g., events 342, 344, and 346) according to the Tx states.

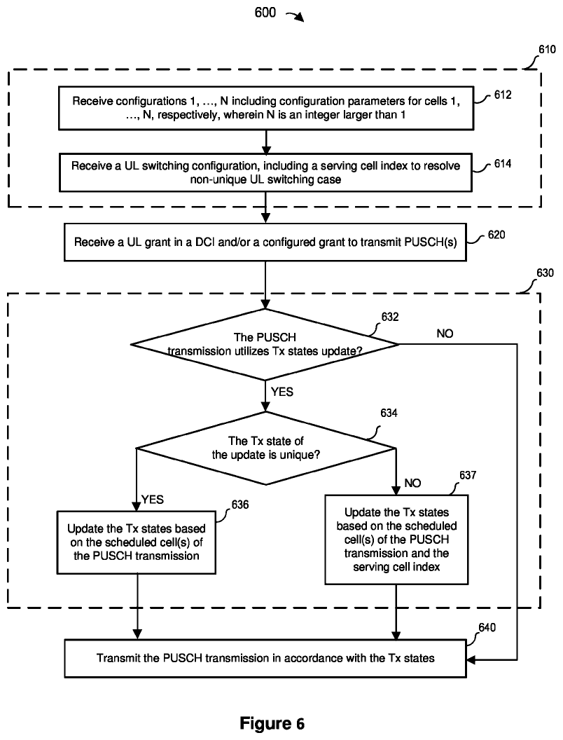

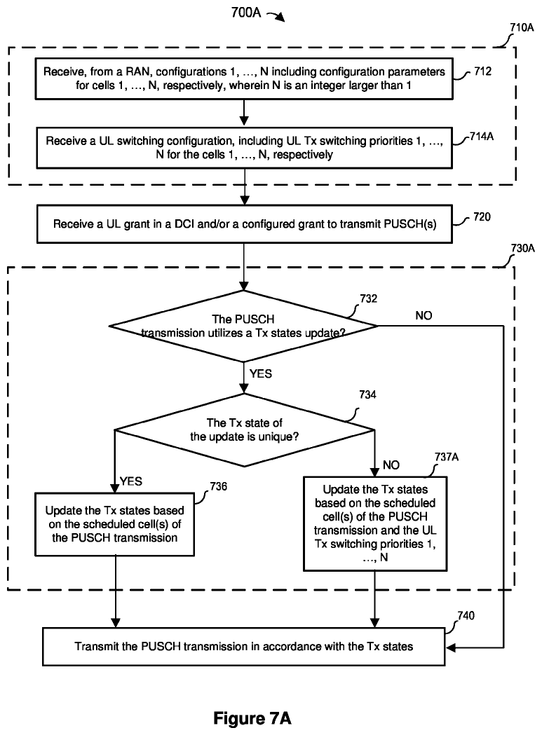

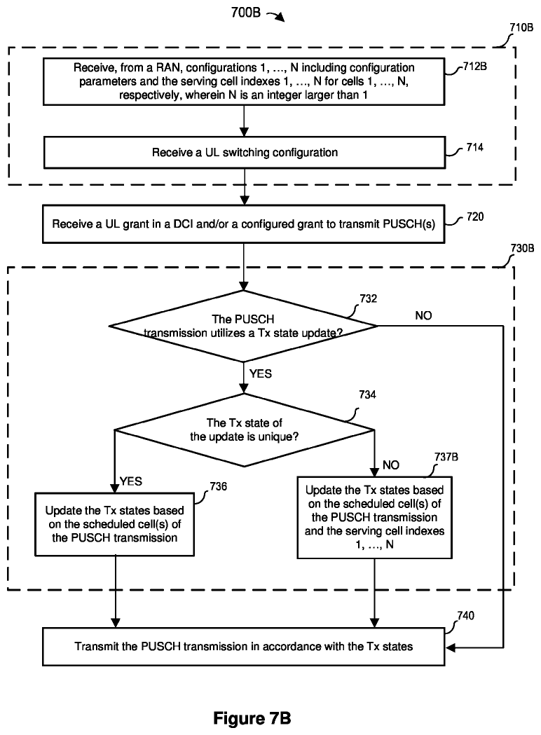

FIGS. 6, 7A, 7B, 8, 9A, and 9B depict detailed procedures and variations of method 500 for a UE to determine Tx states. Generally speaking, events in FIGS. 5-9B that are similar are labeled with similar reference numbers (e.g., event 512 is similar to event 612 of FIG. 6, event 712 of FIGS. 7A and 7B, etc.), with differences discussed below where appropriate. With the exception of the differences shown in the figures and discussed below, any of the alternative implementations discussed with respect to a particular event (e.g., for messaging and processing) may apply to events labeled with similar reference numbers in other figures. Further, it will be understood that FIGS. 6-9B can depict expanded views of events in FIG. 5. For example, block 630 of FIG. 6 including blocks 632, 634, 636, and 637 can detail an expanded view of block 530 of FIG. 5, denoted by a dashed line surrounding the component events. As such, it will be understood that implementations with regard to such expanded events can apply to the version in FIG. 5 and vice versa.

FIG. 6 illustrates an example method 600 of UE procedures that is similar to the method 500, with differences described below. At block 614, the UE (e.g., UE 102) receives a UL switching configuration (e.g., events 314, 514), including a serving cell index (e.g., uplinkTxSwitchingCarrier) for a non-unique UL switching case. At block 632, if the PUSCH transmission does not utilize a Tx state(s) update, the flow proceeds to block 640 where the UE 102 transmits the PUSCH according to the Tx state. At block 632, if the PUSCH transmission can utilize a Tx state update, the flow proceeds to block 634. At block 634, if the Tx state(s) of the update is unique, the flow proceeds to block 636. At block 636, the UE updates the Tx state(s) based on the scheduled cell(s) of the PUSCH transmission. At block 634, if the Tx state(s) of the update is not unique, the flow proceeds to block 637. At block 637, the UE updates the Tx state(s) based on scheduled cell(s) of the PUSCH transmission and the serving cell index (from event 614) for the non-scheduled Tx. The flow then proceeds to block 640 from blocks 636 and/or 637.

As an example of method 600 applicable to scenario 300, the base station 104 transmits 312 a cell group configuration to the UE 102, including first, second, and third serving cell indexes for a first, second, and third cell on the first, second, and third bands, respectively (e.g., event 512). The base station 104 transmits 314 a UL switching configuration to the UE 102 (e.g., event 614). The UE 102 uses a first and second Tx for UL transmission (thus the Tx states and antenna port assignments can be determined according to Table 2). The base station 104 transmits 324 the first DCI to the UE 102, where the first DCI schedules a 2-port PUSCH transmission on the second cell (0P-2P-0P). At event 334, because Case 5 (0T-2T-0T) is associated with antenna port assignments 0P-2P-0P, the UE 102 configures (e.g., event 636) the first and second Tx for the second cell. The UE 102 transmits 344 the first PUSCH to the base station 104, with Tx states in Case 5 (0T-2T-0T). Then the base station 104 transmits 326 a second DCI to the UE 102, where the second DCI schedules a 1-port PUSCH transmission on the first cell (1P-0P-0P). At event 336, the UE 102 configures (e.g., event 636) the first Tx for the first cell and configures (e.g., event 637) the second Tx for the cell with the serving cell index indicated in the UL switching configuration. For example, if the serving cell index indicates the second cell, the UE 102 configures the second Tx for the second cell, then the Tx states become Case 1 (1T-1T-0T). Likewise, if the cell index indicates the first cell, the UE 102 configures the second Tx for the first cell, then the Tx state becomes Case 4 (2T-0T-0T). Finally, the UE 102 transmits 346 the second PUSCH with the Tx state in Case 4 (2T-0T-0T).

FIG. 7A illustrates an example method 700A of UE procedures that is similar to the method 500 and 600, with differences described below. At block 714A, the UE (e.g., UE 102) receives a UL switching configuration (e.g., events 314, 514), including 1, . . . , N priority values (e.g., uplinkSwitchingPrioirty for each serving cell) to 1, . . . , N cell(s)/bands, respectively. At block 737A, the UE 102 updates Tx states based on the scheduled cell(s) of the PUSCH transmission and the UL Tx switching priorities that is configured in the UL switching configuration.

As an example of method 700A applicable to scenario 300, the base station 104 configures 312, for the UE 102, a cell group configuration (e.g., event 512) including a first, second, and third cell on the first, second and third bands, respectively. The base station 104 transmits 314, to the UE 102, a UL switching configuration (e.g., event 714A), including a first, second, and third priority to the first, second, and third cells. The UE 102 uses a first and second Tx for UL transmission (thus the Tx states and antenna port assignments can be determined according to Table 2). The base station 104 transmits 324 the first DCI to the UE 102, where the first DCI schedules a 2-port PUSCH transmission on the second cell (0P-2P-0P). At event 334, the UE 102 configures the first and second antennas for the second cell (Case 5, 0T-2T-0T), because Case 5 is associated with antenna port assignments 0P-2P-0P. The UE 102 transmits 344 the first PUSCH to the base station 104, with Tx states in Case 5 (0T-2T-0T). Then the base station 104 transmits 326 a second DCI to the UE 102, where the second DCI schedules a 1-port PUSCH transmission on the first cell (1P-0P-0P). At event 336, the UE 102 configures the first Tx for the first cell (e.g., event 636), and configures the second Tx for the cell with the highest priority value (e.g., event 737A). For example, if the cell with the highest priority value is the second cell, the UE 102 configures the second Tx for the second cell, thus the Tx state becomes Case 1 (1T-1T-0T). Likewise, if the cell with the highest priority value is the first cell, the UE 102 configures the second Tx for the first cell, thus the Tx state becomes Case 4 (2T-0T-0T). Then the UE 102 transmits 346 the second PUSCH with Tx state in Case 4 (2T-0T-0T).

FIG. 7B illustrates an example method 700B of UE procedures that is similar to the method 500 and 600, with differences described below.

At block 712B, the UE (e.g., UE 102) receives configurations 1, . . . , N including configuration parameters and the serving cell indexes 1, . . . , N for cells 1, . . . , N, respectively, wherein N is an integer larger than 1. At block 737B, the UE 102 updates Tx states based on the scheduled cell(s) of the PUSCH transmission and the serving cell indexes.

The example of applying method 700B to scenario 300 is similar to the example of applying method 700A to scenario 300, with differences described below. The base station 104 transmits 312, to the UE 102, a cell group configuration including serving cell indexes 1, . . . , N for cells 1, . . . , N, respectively. At event 336, the UE configures the first Tx for the first cell (e.g., event 636), and configures the second Tx for the cell with the smallest serving cell index (e.g., event 737B). For example, if the cell with the smallest serving cell index is the second cell, the UE 102 configures the second Tx for the second cell, thus the Tx state becomes Case 1 (1T-1T-0T). Likewise, if the cell with the smallest serving cell index is the first cell, the UE 102 configures the second Tx for the first cell, thus the Tx states become Case 4 (2T-0T-0T). Then the UE 102 transmits 346 the second PUSCH with the Tx state in Case 4 (2T-0T-0T).

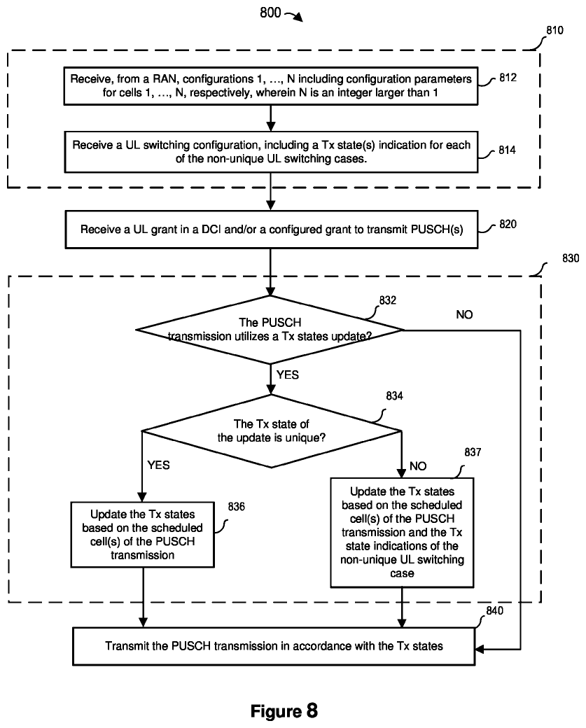

FIG. 8 illustrates an example method 800 of UE procedures that is similar to the methods 500 and 600, with differences described below. At block 814, the UE (e.g., UE 102) receives a UL switching configuration (e.g., events 314, 514), including a Tx states indication for each of the non-unique UL switching cases. At block 837, the UE 102 updates the Tx states based on the scheduled cell(s) of the PUSCH transmission and the Tx state indication of the non-unique UL switching case.

In some implementations regarding method 800, the base station (e.g., BS 104) indicates a Tx state to each antenna port assignment that associates with non-unique UL switching cases. For example, base station 104 configures the UE 102 with UL switching on cells on 3 bands. In some implementations, the base station indicates Tx states and antenna port assignments as shown in Table 4. As shown in the Table 4, the antenna port assignment 1P-0P-0P is associated with Tx state Case 3 (1T-0T-1T). If the UE 102 is to transmit a 1-port PUSCH transmission on the first cell (1P-0P-0P), and the UE 102 is to update the Tx states for the transmission, the UE 102 configures the first Tx for the first cell and the second Tx for the third cell (Case 3 1T-0T-0T), regardless of the current Tx states. Likewise, also shown in the Table 4, the antenna port assignment 0P-1P-0P is associated with the Tx state Case 1 (1T-1T-0T). If the UE 102 is to transmit a 1-port PUSCH transmission on the second cell (0P-1P-0P), and the UE 102 is to update the Tx state for the transmission, the UE 102 configures the first Tx for the first cell and the second Tx for the second cell (Case 1 1T-1T-0T), regardless of the current Tx states.

In some implementations, at block 814, the base station 103 indicates one Tx state to an antenna port assignment associated with non-unique UL switching cases, and the current Tx state of the UE 102. Table 5 shows such an association, where an antenna port assignment can be associated with the same or different Tx states regarding the current Tx state in the UE 102. For example, in one scenario, the UE 102 is to transmit a 1-port PUSCH on the first cell (1P-0P-0P) and is to update the Tx state for the transmission. If the current Tx state of the UE 102 is in Case 2 (0T-1T-1T), the UE 102 configures (as seen in the first row in the Table 5) the first and second Tx for the first and third cells, respectively (Case 3, 1T-0T-T). Likewise, if the current Tx state of the UE 102 is in Case 6 (0T-0T-2T), the UE 102 configures (as seen in the third row in the Table 5) the first and second Tx for the first and second cells, respectively (Case 1, 1T-1T-0T).

In some implementations, the base station 104 configures, for the UE 102, first and second Tx state indications associated with Table 4 and Table 5, respectively. If the UE 102 is to update Tx states of a non-unique UL switching case, the UE checks whether the second Tx state indication (Table 5) is applicable. If the second Tx state indication (Table 5) is not applicable, the UE updates the Tx state according to the first Tx state indication (Table 4). Otherwise, the UE updates the Tx state according to the second Tx state indication (Table 5).

As one example RRC signaling of Table 4, a first table of antenna port assignments that is associated with non-unique UL switching cases is provided (e.g., 1P-0P-0P, 0P-1P-0P, and 0P-0P-1P). In some implementations, a second table of all Tx states (e.g., 1T-1T-0T, 0T-1T-1T, 1T-0T-1T, 2T-0T-0T, 0T-2T-0T, and 0T-0T-2T) is also utilized. Then the base station 104 configures, for the UE 102, a list of integers. In some implementations, the first integer indicates the Tx state for the first non-unique UL switching case in the first table (e.g., 1P-0P-0P), and the value of the first integer indicates a Tx state in the second table (e.g., the value is 1 for the Tx states 1T-1T-0T). Likewise, the second integer indicates the Tx state for the second non-unique UL switching case in the first table (e.g., 1P-0P-0P), and the value of the second integer indicates another Tx state in the second table. Likewise, in some implementations, the Table 5 is implemented similarly using the first table, including the current Tx states and the antenna port assignments of non-unique UL switching cases.

As another example RRC signaling of Table 4, the base station associates non-unique switching cases and Tx states by using RRC parameter naming. For example, the base station configures a parameter nonUniqueSwitchingCase1P-0P-0P with a value selected from ENUMERATED {1T-1T-0T, 0T-1T-IT, 1T-0T-1T, 2T-0T-0T, 0T-2T-0T, 0T-0T-2T}. Then, if the UE 102 is to update the Tx states for a 1P-0P-0P UL transmission and the value of nonUniqueSwitchingCase1P-0P-0P is 1T-IT-0T, the UE 102 switches the Tx states to 1T-1T-0T for the transmission. Likewise, in some implementations, the base station 104 configures parameters nonUniqueSwitchingCase0P-1P-0P and nonUniqueSwitchingCase0P-0P-1P with the same method.

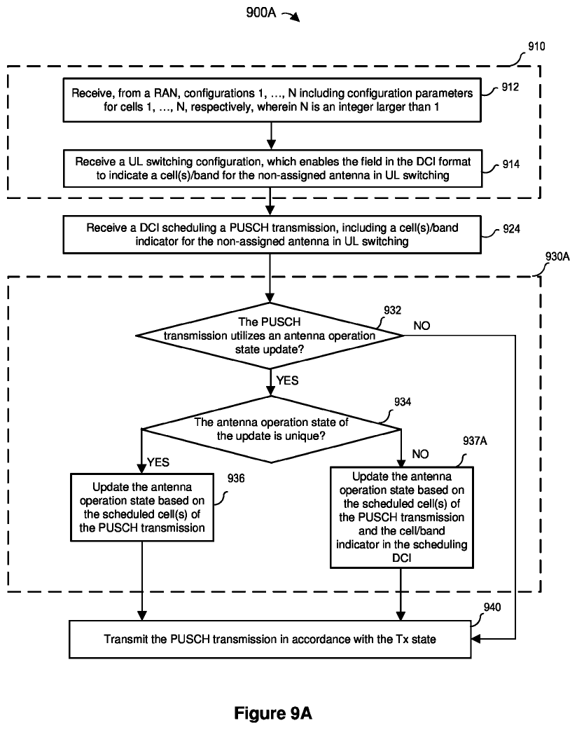

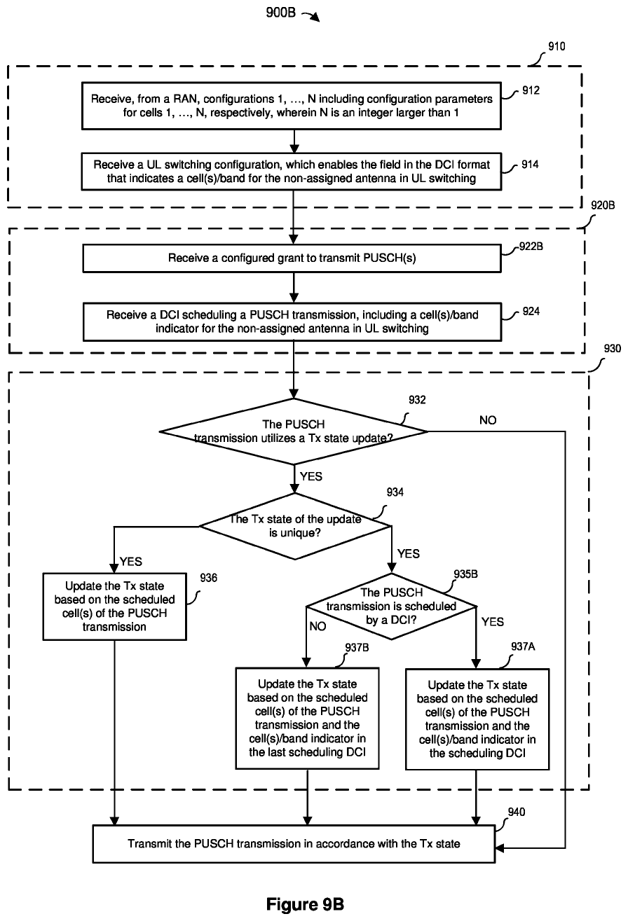

FIG. 9A illustrates an example method 900A of UE procedures that is similar to the method 500 and 600, with differences described below. At block 914, the UE (e.g., UE 102) receives a UL switching configuration (e.g., events 314, 514), which enables the field in the DCI format to indicate a cell(s)/band for the non-assigned Tx in UL switching. At block 924, the UE 102 receives a DCI, which schedules a PUSCH transmission and includes the cell(s)/band indicator for the non-assigned Tx in UL switching. At block 937A, the UE 102 updates Tx states based on the scheduled cell(s) of the PUSCH transmission and the cell(s)/band indicator for the non-assigned Tx in the scheduling DCI.

In some implementations, if the UE 102 is to transmit a PUSCH without Tx states update, the UE 102 ignores the cell(s)/band indicator for the non-assigned Tx in the scheduling DCI.

As an example in which method 900A applicable to scenario 300, the base station 104 transmits 314, to the UE 102, a UL switching configuration to enable a cell(s)/band indictor field in the DCI. Then the base station 104 sends 326 a second DCI to the UE 102, scheduling 346 a second PUSCH transmission. When the UE 102 is to transmit 346 the second PUSCH to the base station 104 and uses a Tx state update to transmit the second PUSCH, the UE 102 determines the Tx states (e.g., events 334 with 937A) according to the cell(s)/band indicator for the non-assigned Tx in the second DCI.

FIG. 9B illustrates an example method 900B of UE procedures that is similar to the method 500, 600, and 900A, with differences described below. At block 922B, the UE (e.g., UE 102) receives a configured grant (e.g., event 322, 522) to transmit PUSCH(s) (e.g., 342 the third PUSCH). At block 935B, if the PUSCH is scheduled by a DCI, the flow proceeds to block 937A. At block 935B, if the PUSCH is not scheduled by a DCI, the flow proceeds to the block 937B. At block 937B, the UE 102 updates the Tx states based on the scheduled cell(s) of the PUSCH transmission and the cell(s)/band indicator for the non-assigned Tx in UL in the last scheduling DCI.

The example of applying method 900B to scenario 300 is similar to the example of method 900A applicable to scenario 300, with differences described below. The UE 102 receives 322, from base station 104, a configured grant scheduling 342 the third PUSCH transmission. In some implementations, if the UE 102 is to transmit the 342 the third PUSCH to the base station 104 and utilizes a Tx state update, the UE 102 determines the Tx states (e.g., event 332 with 937B) according to the cell(s)/band indicator for the non-assigned Tx in 326 the second DCI (the last scheduling DCI before block 342).

The disclosed methods can also apply to other UL channels, for example, PUCCH transmissions triggered by dynamic or semi-persistent scheduled downlink transmission (e.g., HARQ feedback, scheduling request), or RRC configured UL transmission (e.g., channel state information report).

In some implementations, the serving cell index, cell index, carrier index, cell(s)/band indication, and Tx states indication in method 600, 700B, 800, 900A, and 900B refer to a carrier index (e.g., uplinkTxSwitchingCarrier with a value of ENUMERATED (carrier1, carrier2, carrier 3)) configured in UL switching configuration (e.g., uplinkTxSwitching) in each serving cell configuration (e.g., ServingCellConfig). If the frequency range of multiple cells are in the same band and can be operated with a single Tx in a UE, the base station configures, to the UE, the same carrier index to these cells.

In some other implementations, the serving cell index, cell index, carrier index, cell(s)/band indication, and Tx states indication in method 600, 700B, 800, 900A, and 900B refer to a cell index (e.g., secondary cell index, SCellIndex) configured in the cell group configuration (e.g., CellGroupConfig) for cross carrier scheduling. In some implementations, for the primary cell (PCell or special cell in a cell group), the cell index is 0, a default value specified in the 3GPP standard, or a cell index (e.g., PCellIndex) configured by the base station.

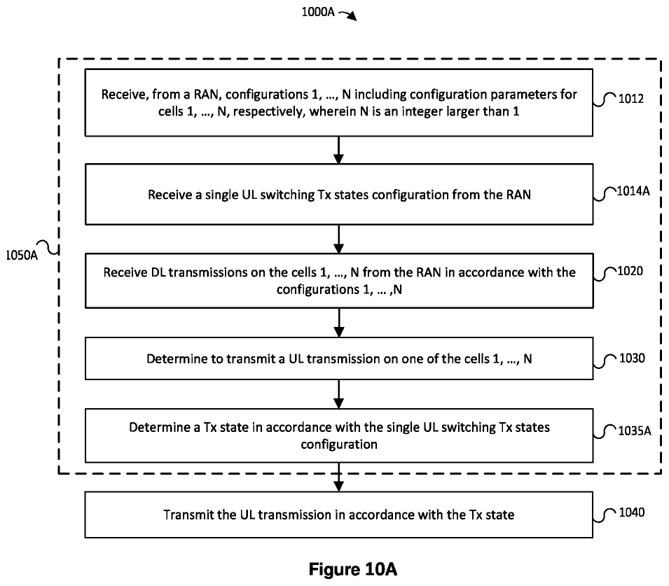

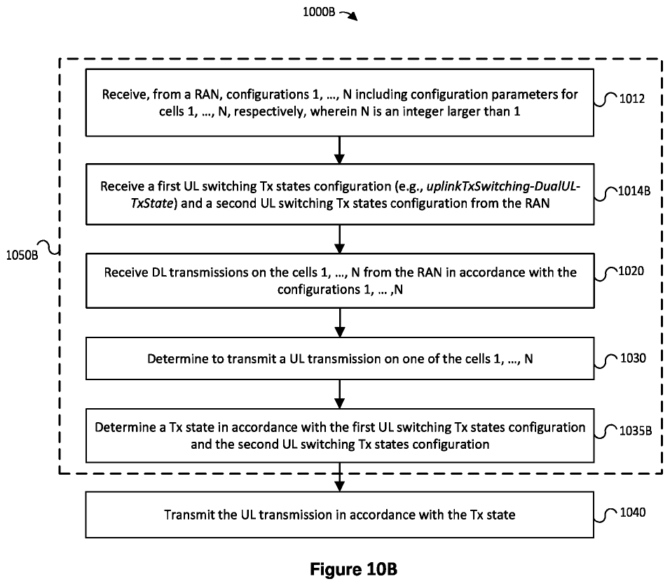

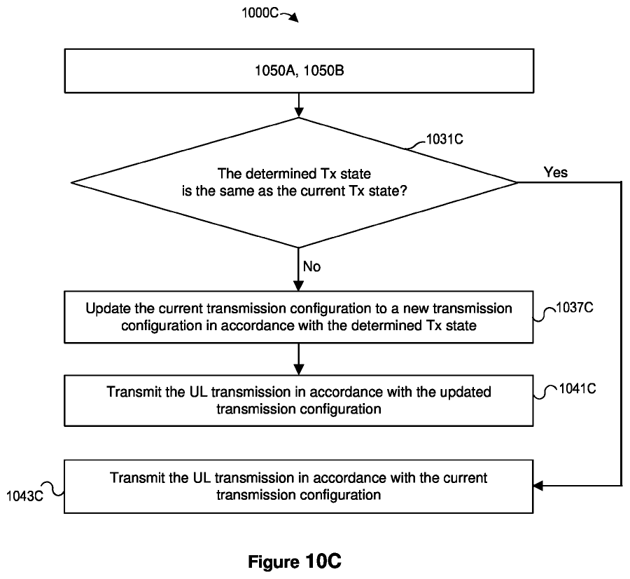

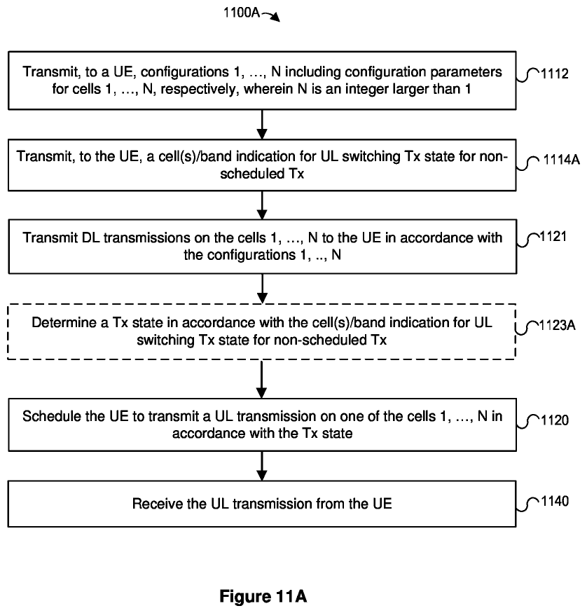

FIGS. 10A, 10B, and 10C illustrate methods of applying single or multiple techniques from methods 600, 700A, 700B, 800, 900A, 900B, and a legacy Tx state configuration (e.g., uplinkTxSwitching-DualUL-TxState) on determining Tx states. The differences between the methods below and other methods described above are described in more detail below. Similar to FIGS. 6-9B, events in FIGS. 10A-10C that are similar to those of FIGS. 5-9B are labeled with similar reference numbers (e.g., event 512 is similar to event 1012 of FIGS. 10A-10C, etc.), with differences discussed below where appropriate. With the exception of the differences shown in the figures and discussed below, any of the alternative implementations discussed with respect to a particular event (e.g., for messaging and processing) may apply to events labeled with similar reference numbers in other figures.

FIG. 10A illustrates an example method 1000A similar to method 500, with differences described below, addressing the UE behaviors communicating with the RAN. In some implementations, the Tx state determination procedures are based on a single UL switching Tx states configuration. At block 1014A, the UE receives a single UL switching Tx states configuration from the RAN (e.g., 514, 614, 714A, 814, 914A, 914B). At block 1035A, the UE 102 updates Tx states in accordance with the single UL switching Tx states configuration.

FIG. 10B illustrates an example method 1000B similar to method 500 and 1000A, with differences described below. At block 1014B, the UE receives a first and a second UL switching Tx states configurations from the RAN (e.g., 514, 614, 714A, 814, 914A, 914B). At block 1035B, the UE 102 updates Tx states in accordance with the first and second UL switching Tx states configurations.

In some examples, the base station 104 configures method 900A/900B with techniques from method 600/700A/700B/800. For a PUSCH scheduled by a DCI format, the UE 102 applies method 900A/900B to update the Tx states. Otherwise, the UE 102 applies techniques according to method 600/700A/700B/800 to update the Tx states.

In some other examples, the base station 104 configures (e.g., in event 312, 314), for the UE 102, a first UL switching Tx states configuration (e.g., uplinkTxSwitching-DualUL-TxState) and a second UL switching Tx states configuration (e.g., events 510, 614, 714A, 712B, 814, 914A). In some implementations, if the value of uplinkTxSwitching-DualUL-TxState is twoT, the UE 102 applies the first UL switching Tx states configuration to update the Tx states when encountering non-unique UL switching cases. In further implementations, if the value of uplinkTxSwitching-DualUL-TxState is oneT, the UE applies the second UL switching Tx states configuration to update the Tx states when encountering non-unique UL switching cases.

FIG. 10C illustrates an example method 1000C, which is similar to methods 1000A and 1000B. When non-unique UL switching cases occurs, the UE (e.g., UE 102) applies blocks 1050A and 1050B to determine Tx states for UL switching. At block 1031C, if the determined Tx states are the same as the current Tx state, the flow proceeds to block 1043C. At block 1043C, the UE 102 transmits the UL transmission in accordance with the current transmission configuration. At block 1031C, if the determined Tx states are not the same as the current Tx state, the flow proceeds to block 1037C. At block 1037C, the UE 102 updates the current transmission configuration to a new transmission configuration in accordance with the determined Tx states. At block 1041C, the UE 102 transmits the UL transmission in accordance with the updated transmission configuration.

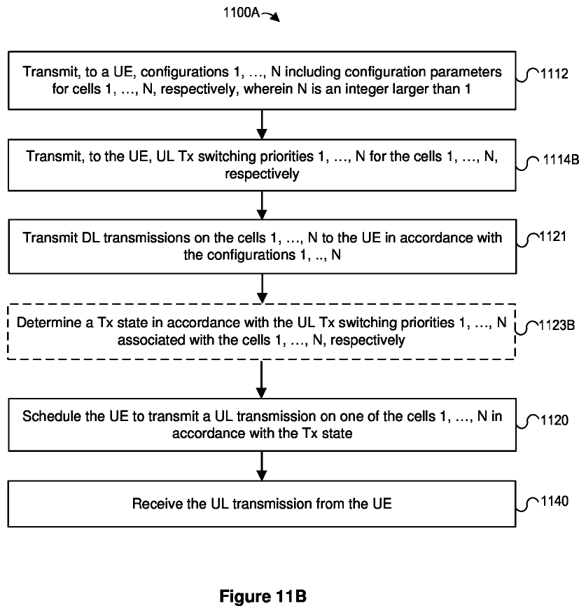

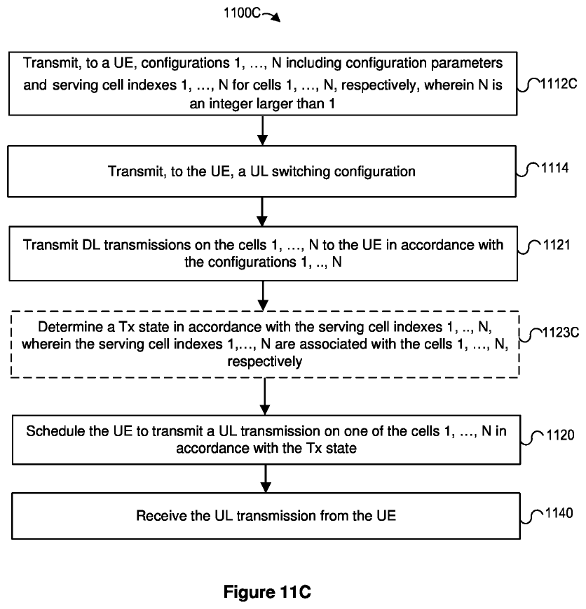

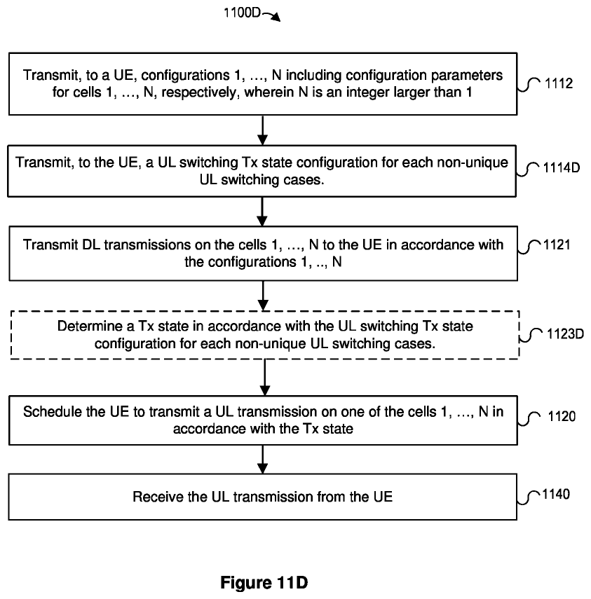

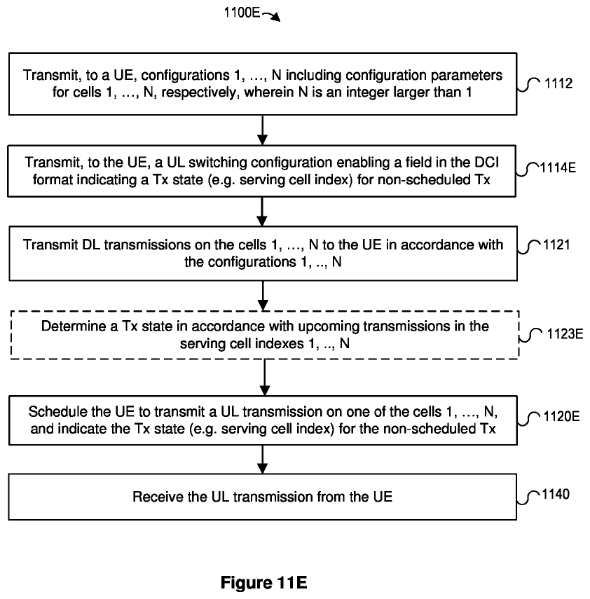

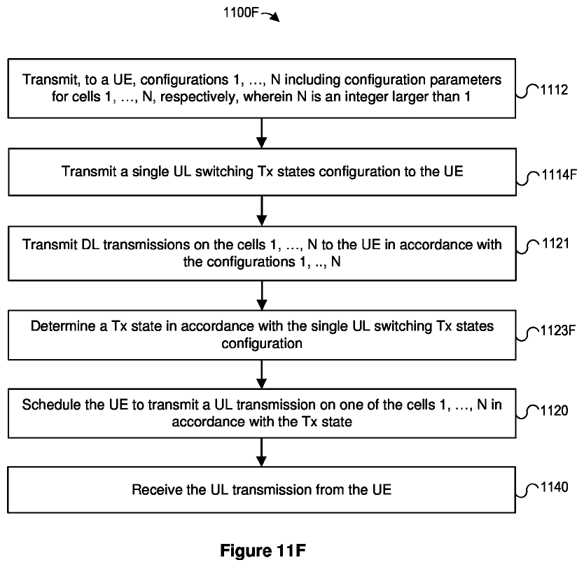

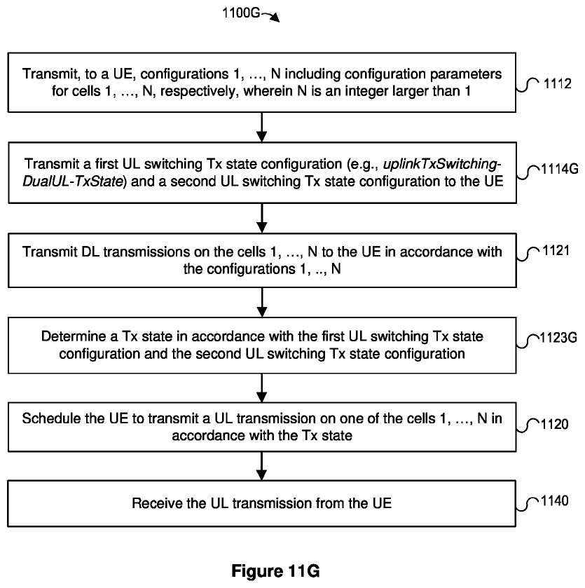

FIGS. 11A, 11B, 11C, 11D, 11E, 11F, 11G illustrate base station procedures configuring UL switching Tx station configuration and/or indicating cell(s)/band for non-scheduled Tx to the UE. Similar to FIGS. 6-10C, events in FIGS. 11A-11G that are similar to those of FIGS. 5-10C are labeled with similar reference numbers (e.g., event 512 is similar to event 1112 of FIGS. 11A-11G, etc.), with differences discussed below where appropriate. With the exception of the differences shown in the figures and discussed below, any of the alternative implementations discussed with respect to a particular event (e.g., for messaging and processing) may apply to events labeled with similar reference numbers in other figures.

FIG. 11A illustrates an example method 1100A reflecting a base station perspective similar to the UE perspective of method 600. The flow begins with block 1112, where the base station 104 transmits, to a UE 102, configurations 1, . . . , N including configuration parameters for cells 1, . . . , N, respectively, wherein N is an integer larger than 1 (e.g., events 512). At block 1114A, the base station 104 transmits, to the UE 102, a cell(s)/band indication for UL switching Tx state for non-scheduled Tx (e.g., event 614). At block 1121, the base station 104 transmits DL transmissions on the cells 1, . . . , N to the UE 102 in accordance with the configurations 1, . . . , N (e.g., event 520). At block 1123A, the base station determines a Tx state in accordance with the cell(s)/band indication for UL switching Tx state for non-scheduled Tx. At block 1120, the base station 104 schedules for the UE 102 to transmit a UL transmission on one of the cells 1, . . . , N in accordance with the Tx state. At block 1140, the base station receives the UL transmission from the UE (e.g., event 540).

FIG. 11B illustrates an example method 1100B reflecting a base station perspective similar to the UE perspective of method 700A. The method 1100B is similar to method 1100A, with differences described below. At block 1114B, the base station 104 transmits, to the UE 102, UL Tx switching priorities 1, . . . , N for the cells 1, . . . , N, respectively (e.g., event 714A). At block 1123B, the base station 104 determines Tx state in accordance with the UL Tx switching priorities 1, . . . N associated with the cells 1, . . . , N, respectively.

FIG. 11C illustrates an example method 1100C reflecting a base station perspective similar to the UE perspective of method 700B. The method 1100C is similar to method 1100A, with differences described below. At block 1112C, the base station 104 transmits, to a UE 102, configurations 1, . . . , N including configuration parameters and serving cell indexes 1, . . . , N for cells 1, . . . , N, respectively, wherein N is an integer larger than 1 (e.g., 712B). At block 1114, the base station 104 transmits, to the UE 102, a UL switching configuration (e.g., event 514). At block 1123C, the base station 104 determines Tx state in accordance with the serving cell indexes 1, . . . , N, wherein the serving cell indexes 1, . . . , N are associated with the cells 1, . . . , N, respectively.

FIG. 11D illustrates an example method 1100D reflecting a base station perspective similar to the UE perspective of method 800. The method 1100D is similar to method 1100A, with differences described below. At block 1114D, the base station 104 transmits, to the UE 102, a UL switching Tx state configuration for each non-unique UL switching cases. At block 1123D, the base station 104 determines a Tx state in accordance with the UL switching Tx state configuration for each non-unique UL switching cases.

FIG. 11E illustrates and example method 1100E reflecting a base station perspective similar to the UE perspective of method 900A and 900B. The method 1100E is similar to method 1100A, with differences described below. At block 1114E, the base station 104 transmits, to the UE 102, a UL switching configuration enabling a field in the DCI format indicating a Tx state (e.g., serving cell index) for non-scheduled Tx. At block 1123E, the base station 104 determines a Tx state in accordance with upcoming transmissions in the serving cell indexes 1, . . . , N. At block 1120E, the base station 104 schedules for the UE 102 to transmit a UL transmission on one of the cells 1, . . . , N, and indicate the Tx state (e.g., serving cell index) for the non-scheduled Tx in the scheduling DCI.

FIG. 11F illustrates and example method 1100F reflecting a base station perspective similar to the UE perspective of method 1000A. The method 1100F is similar to method 1100A, with differences described below. At block 1114F, the base station 104 transmits a single UL switching Tx state configuration to the UE 102. At block 1123F, the base station 104 determines a Tx state in accordance with the single UL switching Tx state configuration.

FIG. 11G illustrates and example method 1100G reflecting a base station perspective similar to the UE perspective of method 1000B. The method 1100G is similar to method 1100A, with differences described below. At block 1114G, the base station 104 transmits a first UL switching Tx state configuration (e.g., uplinkTxSwitching-DualUL-TxState) and a second UL switching Tx state configuration to the UE 102. At block 1123G, the base station 104 determines a Tx state in accordance with the first UL switching Tx state configuration (e.g., uplinkTxSwitching-DualUL-TxState) and a second UL switching Tx state configuration.

In some implementations, the base station 104 proceeds to block 1120 from block 1121 (e.g., skipping events 1123A, 1123B, 1123C, 1123D, 1123E, 1123F, 1123G).

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for managing radio bearers through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

What is claimed is:

1. A method in a user equipment (UE) equipped with a first transmitter and a second transmitter, the method comprising:
transmitting a first uplink transmission using the first transmitter switched to a first frequency band and using a second transmitter switched to a second frequency band; and
receiving, from a radio access network (RAN), an uplink switching configuration for a second uplink transmission using the first transmitter, the uplink switching configuration including (i) a first parameter to indicate whether to switch the second transmitter away from the second frequency band, and (ii) a second parameter indicating to which frequency band the UE is to switch the second transmitter;
transmitting the second uplink transmission in accordance with the uplink switching configuration.

2. The method of claim 1, wherein the first parameter is a binary parameter.

3. The method of claim 2, wherein the first parameter is uplinkTxSwitching-DualUL-TxState.

4. The method of any of the preceding claims, wherein the second parameter indicates a transmission (Tx) state in which each of the first transmitter and the second transmitter is unambiguously mapped to a respective frequency band in a set of frequency bands.

5. The method of claim 4, wherein the set of frequency bands includes exactly three frequency bands.

6. The method of claim 4, wherein the set of frequency bands includes exactly four frequency bands.

7. The method of any of the preceding claims, wherein the second parameter indicates a cell associated with a respective frequency band.

8. The method of any of the preceding claims, wherein the first uplink transmission and the second uplink transmission are physical uplink shared channel (PUSCH) transmissions.

9. The method of claim 8, wherein the uplink switching configuration is received in a downlink control information (DCI) scheduling the PUSCH transmission.

10. The method of any of the preceding claims, further comprising:
switching the first transmitter to a third frequency band for the second uplink transmission.

11. A user equipment (UE) comprising one or more processors and configured to perform the method of any one of the preceding claims.

12. A method in a radio access network (RAN) node, the method comprising:
receiving, from a user equipment (UE) equipped with a first transmitter and a second transmitter, a first uplink transmission over a first frequency band and a second frequency band; and
transmitting, to the UE, an uplink switching configuration for a second uplink transmission over a third frequency band, the uplink switching configuration including (i) a first parameter to indicate whether to switch the second transmitter away from the second frequency band, and (ii) a second parameter indicating to which frequency band the UE is to switch the second transmitter.

13. The method of claim 12, wherein the first uplink transmission and the second uplink transmission are physical uplink shared channel (PUSCH) transmissions.

14. The method of claim 12, wherein the uplink switching configuration is transmitted in a downlink control information (DCI) scheduling the PUSCH transmission.

15. A radio access network (RAN) node comprising one or more processors and configured to perform the method of any one of claims 12-14.
